(19) United States
(12) Patent Application Publication
(10) Pub. No.: US 2017/0312995 A1
(43) Pub. Date: Nov. 2, 2017

(54) METHOD AND DEVICE FOR DETERMINING THE CURING BEHAVIOR OF AN ADHESIVE- OR SEALANT BEAD

(71) Applicant: SCA Schucker GmbH & Co. KG, Bretten (DE)

(72) Inventor: Thomas SPEER, Koenigsbach-Stein (DE)

(73) Assignee: SCA Schucker GmbH & Co. KG, Bretten (DE)

(21) Appl. No.: 15/511,439

(22) PCT Filed: Jul. 23, 2015
(86) PCT No.: PCT/EP2015/066838

§ 371 Date: Mar. 15, 2017

(30) Foreign Application Priority Data
Sep. 25, 2014 (DE) 10 2014 014 016.4

(51) Int. Cl. B29C 65/00; B29C 65/78

(52) U.S. Cl. CPC B29C 66/974; B29C 66/944; B29C 66/92443; B29C 65/7814

(57) ABSTRACT

A method for determining the curing behavior of an adhesive- or sealant bead, the adhesive- or sealant bead being applied to a workpiece, places multiple test bodies on the adhesive- or sealant bead at different, pre-defined placement times, and deformations of the adhesive- or sealant bead, caused by the test bodies, are measured at a pre-defined end time.

The invention relates to a method and an apparatus for determination of the curing behavior of an adhesive bead or sealant bead.

Adhesives and sealants are generally applied to the workpiece in question by means of an application nozzle, in the form of a strand referred to as a bead, wherein the bead can be configured as a continuous bead without gaps, or as a series of a plurality of bead sections disposed at a distance from one another. Further processing of the workpiece provided with the bead must take place in timely manner before curing of the adhesive or sealant. In many applications, it is therefore important that the user knows the curing behavior of the adhesive or sealant before the application process begins. Usually, a test bead is applied to a workpiece and a spatula test is performed, during which a thin spatula is pressed down on the bead at predetermined points in time. In this regard, the deformation of the bead due to the spatula pressure represents a measure of the curing of the adhesive or sealant at the predetermined points in time after its application to the workpiece. However, this method is criticized because it is very greatly dependent on the person performing it, since different persons press down on the bead with the spatula with different force, and even if the spatula test is carried out by a single test person, it is not guaranteed that this person will always press down on the bead with the same force at the different predetermined points in time.

It is therefore the task of the invention to make available a method and an apparatus for determination of the curing behavior of an adhesive bead or sealant bead, which method or apparatus yields more reproducible or more objective results.

This task is accomplished, according to the invention, by a method having the characteristics of claim 1 and an apparatus having the characteristics of claim 8. Advantageous embodiments of the invention are the object of the dependent claims.

The invention is based on the idea that a test body will always apply at least approximately the same force to the bead when it is set onto the bead and acts on it with its weight force, and therefore can yield reproducible and objective results. In this regard, it is preferred that multiple and preferably all the test bodies are configured identically, so that they act on the bead with at least approximately the same weight force. It is advantageous if the test bodies are configured to be identical not only in terms of their weight, but also, if applicable, in terms of their shape and/or the material used, so that the contact surface resting on the bead is also always the same. The test bodies are set onto the bead at different, predetermined set-down time points, and the deformations of the bead caused by the test bodies are measured at a predetermined end time. These serve as a measure for the curing time, so that particularly in the case of a two-component or three-component adhesive or sealant, its composition can be varied once again before it is used in production.

In particular, the depth to which the respective test body sinks into the bead can be used as a measure for curing of the adhesive or sealant at the set-down time points. This depth can furthermore be measured in simple manner. A great sink-in depth means that the adhesive or sealant has cured very little at the set-down time point in question; a low sink-in depth or a sink-in depth of zero means that the adhesive or sealant has already cured greatly or completely at the set-down time point in question.

Preferably, the test bodies are set onto the adhesive bead or sealant bead at constant time intervals, so that measurement values are obtained with regard to set-down time points that have constant intervals from one another, so that an interpolation, for example, is simplified.

According to an advantageous embodiment of the invention, a holding device is set onto the workpiece, which device has linear guides for the test bodies, in which these bodies can be guided linearly in the direction toward the workpiece. The test bodies are then introduced into the linear guides at the set-down time points and set down onto the adhesive bead or sealant bead, so that they impact the bead with their weight. Use of the holding device facilitates reproducibility of the results, in that setting down the test bodies is independent of the skill of the person performing the test, to a great extent, and positioning of the test bodies on the bead is simplified. It is practical if metal pins are used as test bodies; these preferably have a thickness that decreases toward an underside set-down surface. Metal pins have a great specific weight, so that sufficient deformation of the bead can be achieved even when using relatively small test bodies. If the pins have a small set-down surface, this leads to a higher pressure that increases the deformation of the bead even more.

It is advantageous if the holding device is a perforated plate and the test bodies are guided in the holes of the plate, which form the linear guides, with play. In this way, a simple structure of the apparatus according to the invention is achieved.

In the following, the invention will be explained in greater detail using an exemplary embodiment shown schematically in the drawing. The figures show:

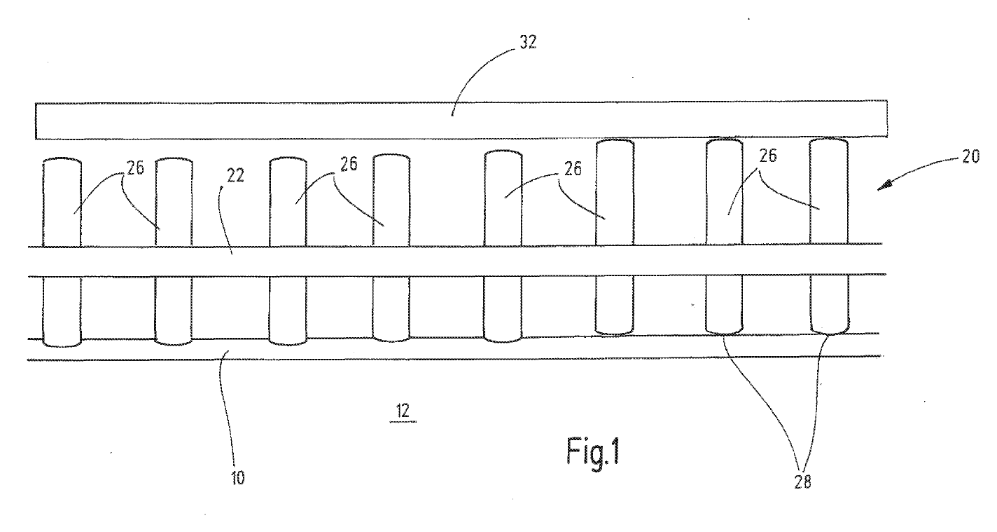

FIG. 1 an adhesive bead applied to a workpiece, with an apparatus for determination of its curing behavior, in a side view, and

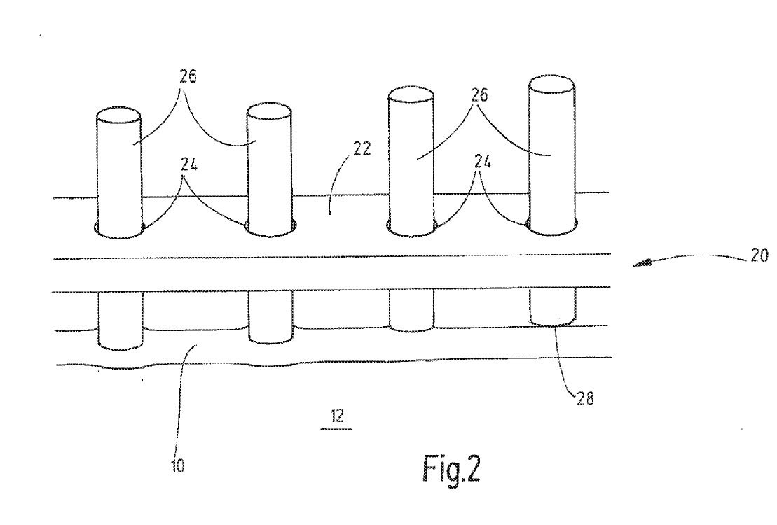

FIG. 2 a representation of a detail from FIG. 1 in a perspective view.

In the drawing, an adhesive bead 10 is shown, which was applied to a workpiece 12. Furthermore, in FIG. 1 an apparatus 20 is shown, which serves for a determination of the curing behavior of the adhesive. The apparatus 20 has a holding device 22 in the form of an elongated plate, which has holes 24 disposed in a row, at equal intervals from one another. The holes 24 form linear guides for a plurality of metal pins 26, which have a cylindrical outer contour and are configured to be at least similar in terms of shape, material, and weight, and are configured to be identical in the exemplary embodiment shown, which pins are set into the hole 24 with some play and are guided there in a direction perpendicular to the surface of the workpiece 12. The cross-section of each of the metal pins 26 decreases toward an underside set-down surface 28, so that its weight rests on a relatively small surface.

For a determination of the curing behavior of the adhesive that forms the bead 10, the bead 10 is first applied to the workpiece 12. Afterward, the plate 22 is set onto the surface of the workpiece 12 by means of support legs, not shown in any detail, and the metal pins 26 are introduced into the holes 24 at constant time intervals, at predetermined set-down time points, and set onto the adhesive bead 10 with their set-down surface 28. In the exemplary embodiment shown here, a first metal pin 26 is set onto the bead 10 one and a half minutes after application of the adhesive bead 10 to the workpiece 12, a second metal pin 26 is set down after three minutes, a third metal pin 26 after four and a half minutes, and so on. Since the adhesive cures over time, the metal pins 26 set onto the bead 10 first sink deeper into it than the metal pins 26 set onto the bead 10 last. This is illustrated in FIG. 1, in which a bar 32 that runs horizontally is laid onto the metal pin 26 set down last, which has practically not sunk into the bead 10 at all. The sink-in depth of the metal pins 26 at the predetermined set-down time points, which is illustrated in FIG. 1 by the distance from the bar 32, is then a characteristic measure of the curing behavior of the adhesive. In this regard, the sink-in depth is measured at a predetermined end time, which is preferably a point in time at which complete curing of the adhesive can be assumed.

In summary, the following should be stated: The invention relates to a method for determination of the curing behavior of an adhesive bead or sealant bead 10, wherein the adhesive bead or sealant bead 10 is applied to a workpiece 12, wherein multiple test bodies 26 are set onto the adhesive bead or sealant bead 10 at different, predetermined set-down time points, and wherein deformations of the adhesive bead or sealant bead 10 caused by the test bodies 26 are measured at a predetermined end time.

1. Method for determination of the curing behavior of an adhesive bead or sealant bead (10), wherein the adhesive bead or sealant bead (10) is applied to a workpiece (12), wherein multiple test bodies (26) are set onto the adhesive bead or sealant bead (10) at different, predetermined set-down time points, and wherein deformations of the adhesive bead or sealant bead (10) caused by the test bodies (26) are measured at a predetermined end time.

2. Method according to claim 1, wherein multiple test bodies (26) and preferably all the test bodies (26) are configured identically.

3. Method according to claim 1 wherein at the end time point, sink-in depths of the test bodies (26) into the adhesive bead or sealant bead (10) are measured.

4. Method according to claim 1, wherein the test bodies (26) are set down onto the adhesive bead or sealant bead (10) at constant time intervals.

5. Method according to claim 1, wherein a holding device (22) is se't down onto the workpiece (12), which device has linear guides (24) for the test bodies (26), in which these can be linearly guided in the direction toward the workpiece (12), and that wherein the test bodies (26) are introduced into the linear guides (24) at the set-down time points to impact the adhesive bead or sealant bead (10) with their weight, and are set down onto the adhesive bead or sealant bead (10).

6. Method according to claim 1, wherein metal pins are used as test bodies (26).

7. Apparatus for determination of the curing behavior of an adhesive bead or sealant bead (10) applied to a workpiece (12), having a holding device (22) for being set onto the workpiece (12), which device has linear guides (24) for displaceable guidance of test bodies (26) in a direction toward the workpiece (12), and having a plurality of identical test bodies (26) for insertion into the linear guides (24) and for impacting the adhesive bead or sealant bead (10) with their weight.

8. Apparatus according to claim 7, wherein multiple test bodies (26) and preferably all the test bodies (26) are configured to be identical.

9. Apparatus according to claim 7, wherein the holding device (22) is a perforated plate and wherein the test bodies (26) are pins, particularly metal pins, guided in the holes (24) of the plate (22) with play.

10. Apparatus according to claim 9, wherein the thickness of the pins (26) decreases toward an underside set-down surface (28).
